(19) United States
(12) Patent Application Publication
(10) Pub. No.: US 2023/0267063 A1
(43) Pub. Date: Aug. 24, 2023

(54) REAL-TIME LATENCY MEASUREMENTS IN STREAMING SYSTEMS AND APPLICATIONS

(71) Applicant: NVIDIA Corporation, Santa Clara, CA (US)

(72) Inventors: Sau Yan Keith Li, San Jose, CA (US); Prashant Khodade, Pune (IN); Paul Alexander Hodgson, Charlotte, NC (US); Seth Schneider, San Jose, CA (US); Prakshep Mehta, Pune (IN); Sayantan Hensh, Kolkata (IN)

(21) Appl. No.: 18/154,237

(22) Filed: Jan. 13, 2023

Related U.S. Application Data
(60) Provisional application No. 63/312,373, filed on Feb. 21, 2022.

(51) Int. Cl. G06F 11/34

(52) U.S. Cl. CPC G06F 11/3457; G06F 11/3419

(57) ABSTRACT

In various examples, to real-time latency measurements in cloud gaming systems and applications are described. For instance, systems and methods may determine a latency associated with an application, such as a gaming application. The latency may include a computing device latency (e.g., a personal computer latency, a game console latency, a cloud-system latency, etc.), a peripheral device latency, a display latency, and/or an end-to-end latency (e.g., a system latency) that is based on the computing device latency, the peripheral device latency, and the display device. In some examples, the systems and methods are able to determine an entirety of the computing device latency, such as the input sampling latency, the application latency, the rendering latency, and the composition latency. In some examples, the systems and methods determine the latencies without the use of specialized hardware and/or without requiring physical input from a user.

### CROSS-REFERENCE TO RELATED APPLICATIONS

This application claims the benefit of U.S. Provisional Application No. 63/312,373, filed on Feb. 21, 2022, which is hereby incorporated by reference in its entirety.

### BACKGROUND

As the number of high-performance and/or real-time sensitive applications increases—such as gaming applications, virtual reality (VR) applications, augmented reality (AR) applications, and/or mixed reality (MR) applications—the performance of computing systems executing these applications becomes more critical. For example, to execute a first-person competitive game, the computing system—e.g., a gaming console, a personal computer, a cloud gaming system, etc.—should be configured such that end-to-end latency of the system is at a level that provides a positive user experience. As such, system latency is an important gaming performance metric, and in many cases, more impactful to the overall gaming experience than frames per second (FPS). Part of the reason why FPS is such a popular performance metric is because it is relatively easy to measure. System latency, on the other hand, is difficult to measure.

A first conventional approach to measure system latency requires the use of a high-speed camera and a modified mouse. For instance, the mouse is modified to provide immediate visual indication (e.g., illuminates) on each click. Using the high-speed camera, the user would capture a video, such as at a high frame rate (e.g., 500 Hertz or greater) of the mouse click and its resulting on-screen effect. To calculate end-to-end latency, the user would then count the number of frames from the mouse lighting up to the first on-screen effect. One shortcoming of this approach is that it requires specialized hardware. Another shortcoming of this approach is that it is a tedious and lengthy process to count the frames for each latency sample.

A second conventional approach to determining system latency uses a Latency Display Analysis Tool (LDAT). The LDAT is a discrete hardware analyzer that uses a luminance sensor to quickly and accurately measure the click-to-photon (click-to-muzzle-flash game action) latency in a game or application. After positioning the LDAT luminance sensor over the monitor, the LDAT may automate mouse clicks and measure the latency of each click. One shortcoming of this approach is that it requires specialized LDAT hardware. Another shortcoming of this approach is that the mouse click automation may not work during actual gameplay.

A third conventional approach to determining system latency uses a latency analyzer module within the display. For instance, the user may connect the mouse to the display, and this latency analyzer module would then measure the latency from the mouse button click to the luminance change on screen (such as gun muzzle flash or flash indicator based on the button click). One shortcoming of this approach is that it requires an monitor enabled with a latency analyzer. Another shortcoming of this approach is that each sample requires the mouse button click to trigger a change of luminance on screen.

A fourth conventional approach determines game-to-render (G2R) latency using in-game markers. This approach is software based and may measure per-frame system latency. However, this approach has the shortcoming of missing the input sampling latency and the composition latency, which are significant components of system latency. For instance, the input sampling latency may vary greatly depending on the game engine and the frame rate. Additionally, the composition latency may vary depending on system configurations and settings, such as Microsoft Hybrid Graphics (MSHybird), GSYNC, VSYNC, and full-screen/windowed modes. Another shortcoming of this approach is that it was designed for specific GPU drivers and, as such, may not be applicable in many situations.

### SUMMARY

Embodiments of the present disclosure relate to real-time latency measurements in streaming systems and applications. Systems and methods are disclosed that determine a latency associated with an application, such as a gaming application. The latency may include a computing device latency (e.g., a personal computer latency, a game console latency, a cloud-system latency, etc.), a peripheral device latency, a display latency, and/or an end-to-end latency (e.g., a system latency) that is based on the computing device latency, the peripheral device latency, and the display device. In some embodiments, the systems and methods are able to determine an entirety of the computing device latency, such as, but not limited to, the input sampling latency, the application latency, the rendering latency, and the composition latency.

In contrast to conventional systems, such as conventional systems that use software to determine application latencies (e.g., the fourth approach that determines G2R), the current systems, in some embodiments, are able to determine an entirety of the computing device latency, including the input sampling latency and the composition latency. This is important when determining the end-to-end latency of the system since, as described herein, the input sampling latency and the composition latency may vary based on the system configurations and/or the settings of the application. Additionally, in contrast to conventional systems, such as conventional systems that use specialized hardware (e.g., high-speed cameras, the LDAT, a latency analyzer module, etc.) to determine system latencies, the current systems, in some embodiments, are able to determine latencies without the use of specialized hardware. Rather, the current systems are able to determine the latencies using software, such as software executing on the computing device that provides the application.

### BRIEF DESCRIPTION OF THE DRAWINGS

The present systems and methods for real-time latency measurements in streaming systems and applications are described in detail below with reference to the attached drawing figures, wherein:

FIG. 1 is an example of determining latencies associated with a system that is providing an application, in accordance with some embodiments of the present disclosure;

FIG. 2 illustrates an example of an application generating data (e.g., messages) associated with processing frames, in accordance with some embodiments of the present disclosure;

FIG. 3 illustrates an example of determining a device latency associated with a system, in accordance with some embodiments of the present disclosure;

FIG. 4 illustrates an example of determining a device latency associated with a system when one or more frames are dropped, in accordance with some embodiments of the present disclosure;

FIG. 5 illustrates an example of determining a device latency associated with a system that generates additional frames for an application, in accordance with some embodiments of the present disclosure;

FIG. 6 is a flow diagram showing a method for determining a latency associated with a computing device, in accordance with some embodiments of the present disclosure;

FIG. 7 is a flow diagram showing a method for using markers to determine a latency associated with a computing device, in accordance with some embodiments of the present disclosure;

FIG. 8 is a block diagram of an example content streaming system suitable for use in implementing some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to real-time latency measurements in streaming systems and applications. Disclosed embodiments may be comprised in a variety of different systems such as streaming systems (e.g., game streaming systems), automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for processing data, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

For instance, a system(s) may be configured to determine at least a computing device latency associated with an application, such as a gaming application. As described herein, the computing device may include, but is not limited to, a personal computer, a game console, a cloud-based system, a mobile device, and/or any other type of computing device that is capable of executing the application. Additionally, the computing device latency may include different latencies (also referred to as “latency components”) caused by different components and/or processes, such as an input sampling latency, an application latency, a render latency, a composition latency, and/or so forth. As such, and in some examples, the system(s) may be configured to determine different latency components of the computing device latency and then use the latency components to determine the final computing device latency for the computing device executing the application.

For instance, the system(s) may be configured to determine a first latency component of the computing device latency, where the first latency component may be associated with the input sampling latency. To determine the first latency component, the system(s) may determine times (also referred to, in some examples, as “first times”) that input events associated with the application occur and other times (also referred to, in some examples, as “second times”) that the computing device starts to simulate frames associated with the input events. In some examples, the input events are associated with actual inputs provided to the application, such as via a peripheral device. In some examples, the input events are associated with simulated inputs (e.g., pings) provided to the application, such as at given time intervals (e.g., every 100 milliseconds, 300 milliseconds, 1 second, etc.), or the simulated inputs are provided at random time intervals (e.g., not fixed time intervals).

To determine the first latency component using the first times and the second times, the system(s) may determine a respective difference between a first time that an input event occurs and a second time that a frame associated with the input event starts simulation. In some examples, the system(s) determines the respective differences for more than one input event (e.g., each input event). The system(s) may then determine the first latency component based on the differences between the first times and the second times. In some examples, the system(s) may determine the first latency component as the average of the differences (e.g., over a given time period, such as 1 second, 10 seconds, 1 minute, etc.). By taking the average of the differences to determine the first latency component, the system(s) may account for the fact that the input sampling latency varies during the instance of the application. However, in other examples, the system(s) may determine the first latency component using one or more additional and/or alternative techniques, such as the minimum of the differences, the median of the differences, the maximum of the differences, and/or the like.

The system(s) may also be configured to determine a second latency component of the computing device latency, where the second latency component may be associated with the application latency and/or the total time the CPU spends on the frames. To determine the second latency component, the system(s) may determine additional times (also referred to, in some examples, as “third times”) that present calls associated with the frames occur. The system(s) may then determine a respective difference between a second time(s) that a frame begins simulation and a third time(s) that the present call associated with the frame occurs. In some examples, the system(s) determines the respective differences for more than one frame (e.g., each frame). In some examples, the system(s) may determine a respective second latency component for each difference, or the system(s) may determine the second latency component using more than one of the differences, such as—for example and without limitation—based on the average of the differences, the minimum of the differences, the median of the differences, the maximum of the differences, and/or the like.

The system(s) may also be configured to determine a third latency component of the computing device latency, where the third latency component may be associated with the render latency and/or the composition latency. To determine the third latency component, the system(s) may determine yet another set of times (also referred to, in some examples, as “fourth times”) that frame buffer flips associated with the frames occur. The system(s) may then determine a respective difference between a third time(s) that a present call associated with a frame occurs and a fourth time(s) that a frame buffer flip associated with the frame occurs. In some examples, the system(s) determines the respective differences for more than one frame (e.g., each frame). In some examples, the system(s) may determine a respective third latency component for each difference, or the system(s) may determine the third latency component using more than one of the differences, such as based on the average of the differences, the minimum of the differences, the median of the differences, the maximum of the differences, and/or the like.

The system(s) may then determine the computing device latency using the first latency component, the second latency component, and/or the third latency component. In some examples, the system(s) may determine the computing device latency per frame, such as using (e.g., adding) a difference associated with the first latency component, a difference associated with the second latency component, and a difference associated with the third latency component. In some examples, the system(s) may use the average of the differences associated with the first latency component and/or the average of the differences associated with the third latency component when determining the computing device latency. For example, the system(s) may determine the computing device latency using (e.g., adding) the average of the differences associated with the first latency component, a difference associated with the second latency component, and a difference associated with the third latency component. The system(s) may perform such processes to determine the computing device latency since, as described herein, the first latency component, the second latency component, and/or the third latency component may vary.

The system(s) may then use the computing device latency to determine an end-to-end latency associated with the system. As described herein, in some examples, the end-to-end latency may include at least a peripheral latency associated with a peripheral device (e.g., a game controller, a mouse, a keyboard, a camera, a microphone, and/or any other input device), the computing device latency associated with the computing device, and a display latency associated with a display device and/or another output device of the display device (e.g., audio output by a speaker(s)). For example, the system(s) may determine the end-to-end latency by adding the peripheral latency, the computing device latency, and the display latency. Additionally, in some examples, such as when the system is associated with a cloud-based system, such as a cloud-based system that provides games to users, the end-to-end latency may include one or more other latencies, such as a network latency associated with sending and receiving data, a processing latency associated with processing (e.g., encoding, decoding, etc.) the data that is sent and/or received, and/or the like.

In some examples, the system(s) may continue to perform one or more of these processes to continue determining one or more of the latencies, such as at given frames. For instance, the system(s) may determine one or more of the latencies at each frame, every other frame, every fifth frame, every tenth frame, and/or any other combination of frames. In some examples, the system(s) may continue to perform one or more of these processes to continue determining one or more of the latencies, such as at given time intervals. The given time intervals may include, but are not limited to, every 100 milliseconds, every 300 milliseconds, every second, every 5 seconds, every 10 seconds, and/or any other time interval. In some examples, the system(s) may also provide one or more of the latencies, such as to one or more users. For instance, the system(s) may cause the one or more latencies to be displayed to a user such that the user is able to determine the performance of the system when providing the application.

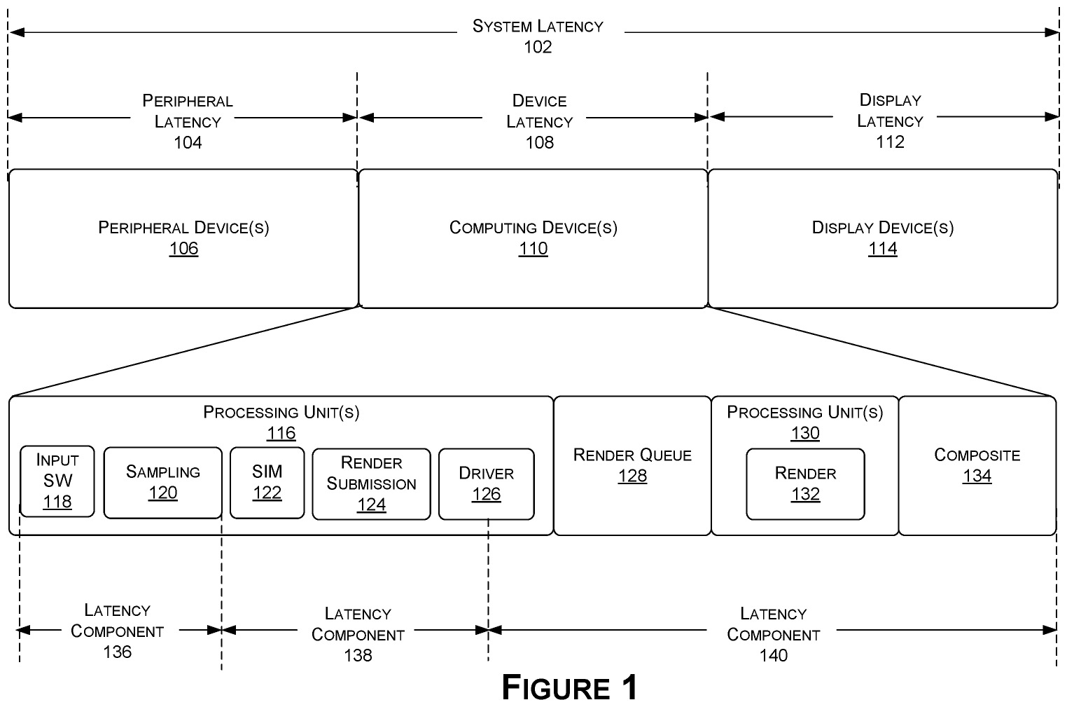

With reference to FIG. 1, FIG. 1 is an example of determining a system latency 102 associated with a system executing an application, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown by the example of FIG. 1, the system latency 102 may be created by one or more components of the system that provide the application. For instance, the system latency 102 may include at least a peripheral latency 104 associated with one or more peripheral devices 106, a device latency 108 associated with one or more computing devices 110, and a display latency 112 associated with one or more displays 114. As described herein, the peripheral device(s) 106 may include, but is not limited to, a game controller, a mouse, a keyboard, a touch-sensitive display, a microphone, a camera, and/or any other device that is capable of receiving input. Additionally, the computing device(s) 110 may include, but is not limited to, a personal computer (e.g., a client device(s) 804), a game console (e.g., a client device(s) 804), a cloud-based system (e.g., application server(s) 802), a mobile device, and/or any other device capable of executing an application. While the example of FIG. 1 illustrates the system latency 102 as including the peripheral latency 104, the device latency 108, and the display latency 112, in other examples, the system latency 102 may include one or more additional and/or alternative latencies, such as a network latency or a processing latency (e.g., in cloud-based system environments).

As further illustrated in the example of FIG. 1, the computing device(s) 110 may include one or more components that are associated with the device latency 108. For instance, the computing device(s) 110 may include one or more processing units 116, such as one or more central processing units, that perform first processing associated with the application. For instance, and as shown, the processing unit(s) 116 may include an input software component 118 (e.g., a universal serial bus (USB) software component) that receives input data associated with the application from the peripheral device(s) 106, a sampling component 120 that samples for the input data (e.g., at given time intervals), a simulation component 122 that simulates frames for the application, a render submission component 124 that submits the rendered frames, and a driver component 126 that helps facilitate communication of the frames, such as between other components of the computing device(s) 110.

The computing device(s) 110 may also include a render queue 128 that is configured to store the rendered frames before further processing. Additionally, the computing device(s) 110 may include one or more additional processing units 130, such as one or more graphics processing units. The processing unit(s) 130 may include a render component 132 that is configured to render the frames received from the render queue 128. Furthermore, the computing device(s) 110 may include a composite component 134 that is configured to perform final processing on the frames before the frames are sent for the display(s) 114. As described herein, one or more of these components (e.g., each of the components) of the computing device(s) 110 may contribute to the device latency 108.

In some examples, the computing device(s) 110 (e.g., the application being executed by the computing device(s) 110) may generate data associated with the processing of the frames that occurs by the computing device(s) 110. For instance, the computing device(s) 110 may generate data for a frame representing a time that an input event occurs, data representing a time that simulation of the frame associated with the input event starts, data representing a time that the input event is sampled, data representing a time that the simulation of the frame ends, data representing a time that a rendering of the frame starts, data representing a time that the rendering of the frame ends, data representing a time that presenting of the frame starts, data representing a time that presenting of the frame ends (e.g., a time that a present call associated with the frame occurs), data representing a time that a buffer flip associated with the frame occurs, and/or the like.

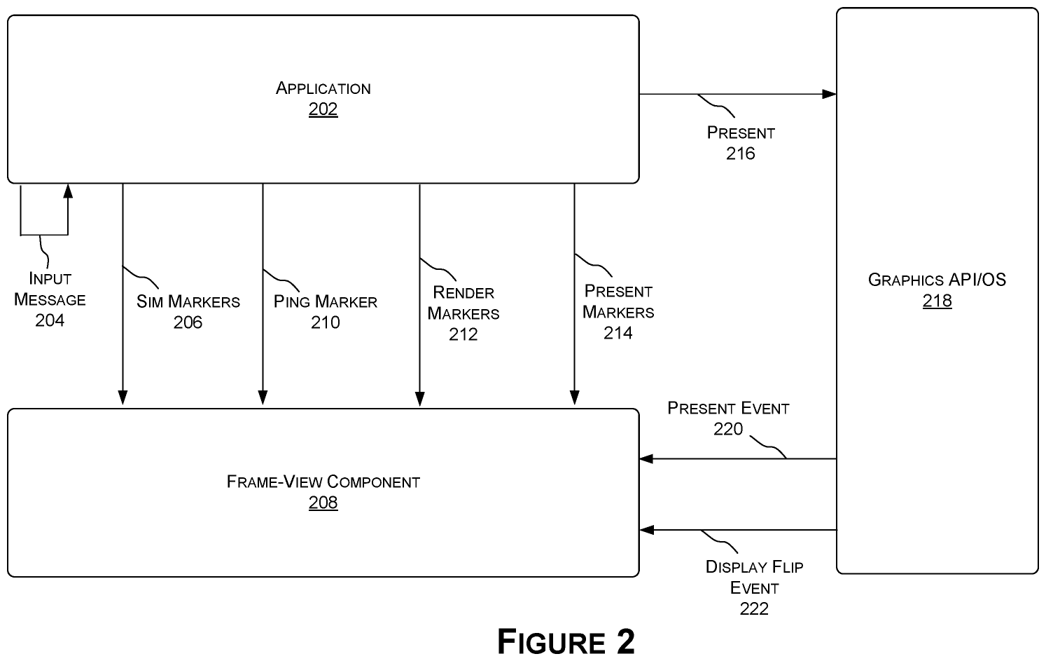

For instance, FIG. 2 illustrates an example of an application 202 generating data (e.g., event messages) associated with processing a frame, in accordance with some embodiments of the present disclosure. As described herein, in some examples, the computing device(s) 110 (e.g., the application 202) may generate (e.g., post) input messages 204, such as at a given time intervals. The given time intervals may include, but are not limited to, 100 milliseconds, 300 milliseconds, 1 second, 5 seconds, and/or any other time interval. In some examples, the computing device(s) 110 (e.g., the application 202) may generate (e.g., post) input messages 204 at random intervals. In either of the examples, and for an input message, the application 202 may be configured to generate data representing a time that the input message was generated.

The application 202 may then be configured to generate a marker 206 (e.g., data) representing a time that simulation associated with the frame starts. The marker 206 may include and/or be associated with an identifier corresponding to the frame. As described herein, the identifier may include, but is not limited to, a numerical identifier, an alphabetic identifier, an alphanumerical identifier, and/or any other type of identifier. In some examples, the application 202 may send the marker 206 to a frame-view component 208 that is configured to store the marker 206 and/or perform one or more of the processes described herein to determine one or more latencies. In some examples, the application 202 may also be configured to generate a marker 206 (e.g., data) representing a time that the simulation associated with the frame ends.

The application 202 may also be configured to generate a marker 210 (e.g., data) representing a time that the input message was sampled by the application 202. The marker 210 may also include and/or be associated with the identifier corresponding to the frame for which the input event reflects. In some examples, the application 202 may send the marker 210 to the frame-view component 208.

The application 202 may also be configured to generate a marker 212 (e.g., data) representing a time that rendering of the frame starts. The marker 212 may also include and/or be associated with the identifier corresponding to the frame. In some examples, the application 202 may also be configured to generate a marker 212 (e.g., data) representing a time that rendering of the frame ends. In such examples, the marker 212 may also include and/or be associated with the identifier corresponding to the frame. In some examples, the application 202 may send the marker(s) 212 to the frame-view component 208.

The application 202 may also be configured to generate a marker 214 (e.g., data) representing a time from which presentation of the frame begins. The marker 214 may also include and/or be associated with the identifier corresponding to the frame. In some examples, the application 202 may also be configured to generate a marker 214 (e.g., data) representing a time that presenting the frame ends. In such examples, the marker 214 may also include and/or be associated with the identifier corresponding to the frame. In some examples, the application 202 may send the marker(s) 214 to the frame-view component 208.

As further illustrated in the example of FIG. 2, the application 202 may be configured to send present data 216 associated with the presenting of the frame to a graphics application programming interface (API) and/or operating system (OS) 218. In some examples, the present data 216 may correspond to a present call. The graphics API and/or OS 218 may then send, to the frame-view component 208, present event data 220 representing when the frame is presented by the graphics API and/or OS 218 and/or display flip data 222 representing a time that a buffer frame flip associated with the frame occurs. In some examples, the frame-view component 208 may then be configured to generate a list using the marks, such as a list that indicates each of the events, the respective times associated with each of the events, the identifier of the frame associated with each of the events, and/or any other information associated with the events.

Referring back to the example of FIG. 1, the device latency 108 may include various latency components, such as a first latency component 136 associated with a time period between when the input event occurs and when simulation of the frame associated with the input event starts. For example, the first latency component 136 may be associated with the input sampling latency. To determine the first latency component 136, a system(s) (e.g., the application 202, the frame-view component 208, an application server(s) 802, a client device(s) 804, etc.) may determine times (also referred to as “first times”) that the input events associated with the application occur (e.g., when the input messages 204 occur) and times (also referred to as “second times”) that frames associated with the input events are simulated by the computing device(s) 110 (e.g., times indicated by the markers 206).

For instance, to determine the first latency component 136 using the first times and the second times, the system(s) may determine a respective difference between a first time that an input event occurs and a second time that a frame associated with the input event is simulated. In some examples, the system(s) determines the respective differences for more than one input event (e.g., each input event). The system(s) may then determine the first latency component 136 based on the differences between the first times and the second times. In some examples, the system(s) may determine the first latency component 136 as the average of the differences (e.g., over a given time period, such as 1 second, 10 seconds, 1 minute, etc.). By taking the average of the differences to determine the first latency component 136, the system(s) may account for the fact that the input sampling latency varies during the instance of the application. However, in other examples, the system(s) may determine the first latency component 136 using one or more additional and/or alternative techniques, such as the minimum of the differences, the median of the differences, the maximum of the differences, and/or the like.

In some examples, the system(s) (e.g., the application 202, the frame-view component 208, etc.) may use the markers associated with the frames to determine the first latency component 136. For instance, and referring back to the example of FIG. 2, the system(s) may use the marker 210 to identify the frame that is associated with an input message 204 since, as described herein, the marker 210 indicates the frame for which the input event was sampled. The systems(s) may also use the marker 210 and the marker 206 to determine when simulation for the frame associated with the input message 204 started. For instance, the system(s) may match the identifier from the marker 206 with the identifier from the marker 210. The system(s) may then determine a difference between the time (e.g., a first time) that the input message 204 occurred and the time (e.g., a second time) that the simulation for the frame associated with the input message 204 started.

The system(s) may perform these processes to determine multiple time differences between when input messages 204 occur and simulations for frames associated with the input messages 204 start. In some examples, the system(s) may then determine the first latency component 136 as the average of the time differences. For example, the system(s) may determine the first latency component 136 as the average of the differences over a time interval such as, but not limited to, one second, five seconds, ten seconds, and/or any other interval. However, in other examples, the system(s) may determine the first latency component 136 using one or more additional and/or alternative techniques, such as the minimum of the differences, the median of the differences, the maximum of the differences, and/or the like.

As further illustrated in the example of FIG. 1, the device latency 108 may include a second latency component 138 associated with a time period between when the simulation of the frame associated with the input event starts and a present call associated with the frame occurs. For example, the second latency component 138 may be associated with the application latency and/or the time that a CPU spends on the frame. To determine the second latency component 138, the system(s) (e.g., the application 202, the frame-view component 208, etc.) may determine times (also referred to as “third times”) that present calls associated with the frames occur. The system(s) may then determine a respective difference between a second times that a frame is simulated and a third time that the present call associated with the frame occurs. In some examples, the system(s) determines the respective differences for more than one frame (e.g., each frame). In some examples, the system(s) may then determine a respective second latency component 138 for each difference, or the system(s) may determine the second latency component 138 using more than one of the differences, such as based on the average of the differences, the minimum of the differences, the median of the differences, the maximum of the differences, and/or the like.

In some examples, the system(s) (e.g., the application 202, the frame-view component 208, etc.) may use the markers associated with the frames to determine the second latency component 138. For instance, and referring back to the example of FIG. 2, the system(s) may use the marker 206 to determine a time (e.g., a second time) that the simulation associated with the frame starts. Additionally, the system(s) may use the marker 214 and/or the present event 220 to determine a time (e.g., a third time) that the present call associated with the frame occurs. In some examples, the system(s) may associate the marker 206 with the marker 214 and/or the present data 216 using the identifier corresponding to the frame. For instance, and as described herein, both the marker 206 and the marker 214 and/or the present data 216 may represent the identifier. In some examples, the system(s) may use the timing between marker 214 and the present event 220 in order to associate the marker 206 with the marker 214, such as by determining that the present event 220 includes the first present event after the marker 214. In such examples, the system(s) may perform such processes based on the present data 216 and/or the present event 220 not representing the identifier. In any of these examples, the system(s) may then determine the second latency component 138 as the difference between the times.

Referring back to the example of FIG. 1, the device latency 108 may also include a third latency component 140 associated with a time period between when the present call associated with the frame occurs and a frame buffer flip associated with the frame occurs. For example, the third latency component 140 may be associated with the render latency and/or the composition latency. To determine the third latency component 140, the system(s) (e.g., the application 202, the frame-view component 208, etc.) may determine times (also referred to as “fourth times”) that the frame buffer flips associated with the frames occur. The system(s) may then determine a respective difference between a third time that a present call associated with a frame occurs and a fourth time that a frame buffer flip associated with the frame occurs. In some examples, the system(s) determines the respective differences for more than one frame (e.g., each frame). In some examples, the system(s) may then determine a respective third latency component 140 for each difference, or the system(s) may determine the third latency component 140 using more than one of the differences, such as based on the average of the differences, the minimum of the differences, the median of the differences, the maximum of the differences, and/or the like.

In some examples, the system(s) (e.g., the application 202, the frame-view component 208, etc.) may use the markers associated with the frames to determine the third latency component 140. For instance, and referring back to the example of FIG. 2, the system(s) may use the marker 214 and/or the present data 216 to determine the time (e.g., the third time) the present call associated with the frame occurs. The system(s) may also use the present data 216, the present event data 220, and/or the display flip data 222 to determine a time (e.g., a fourth time) that the frame buffer flip associated with the frame occurs. For instance, since the display flip data 222 may not include the identifier corresponding to the frame, the system(s) may use a timing between the present marker 214 and/or the present event data 220 to determine that the display flip data 222 is associated with the frame. For example, the system(s) may determine that the frame buffer flip associated with the display flip data 222 should be associated with the same frame as the present marker 214 and/or the present data 216 since that frame was just presented to the graphics API/OS 218.

The system(s) may then determine the third latency component 140 as the difference between the times. In some examples, such as when the system(s) determines multiple differences between present calls and frame buffer flips for multiple frames, the system(s) may perform one or more additional and/or alternative techniques to determine the third latency component 140. For a first example, the system(s) may determine the third latency component 140 as the averages of the differences over a time interval such as, but not limited to, one second, five seconds, ten seconds, and/or any other interval. For a second example, the system(s) may determine the third latency component 140 as the minimum of the differences, the median of the differences, the maximum of the differences, and/or the like.

Referring back to the example of FIG. 1, the system(s) may use the first latency component 136, the second latency component 138, and/or the third latency component 140 to determine the device latency 108. For example, the system(s) may determine the device latency 108 by adding the first latency component 136, the second latency component 138, and the third latency component 140. As described herein, in some examples, when determining the device latency 108, one or more of the first latency component 136, the second latency component 138, or the third latency component 140 may be averaged, such as over a period of time, based on multiple frame calculations. For example, the first latency component 136 and/or the third latency component 140 may be average since the input sampling latency and/or the composition latency may vary based on one or more factors, such as system configurations and/or settings.

The system(s) may also perform one or more processes to determine the peripheral latency 104 associated with the peripheral device(s) 106 and/or the display latency 112 associated with the display device(s) 114. Additionally, the system(s) may determine the system latency 102 (e.g., the end-to-end latency) based at least on the peripheral latency 104, the device latency 108, and the display latency 112. For example, the system(s) may determine the system latency 102 by adding the peripheral latency 104, the device latency 108, and the display latency 112. In some examples, such as when the application is executing on a cloud-based system (e.g., an application server(s) 802), the system(s) may determine the system latency 102 using one or more additional latencies.

For example, the system(s) may determine a latency associated with a client device (e.g., a peripheral device 106, a client device 804) sending data (e.g., input data) to the cloud-based system, a latency associated with the cloud-based system sending data (e.g., video data) to the client device, a latency associated with the client device and/or the cloud-based system processing data (e.g., encoding the data, decoding the data, etc.) for transmission, and/or any other latency. The system(s) may then further determine the system latency 102 by adding one or more of these additional latencies.

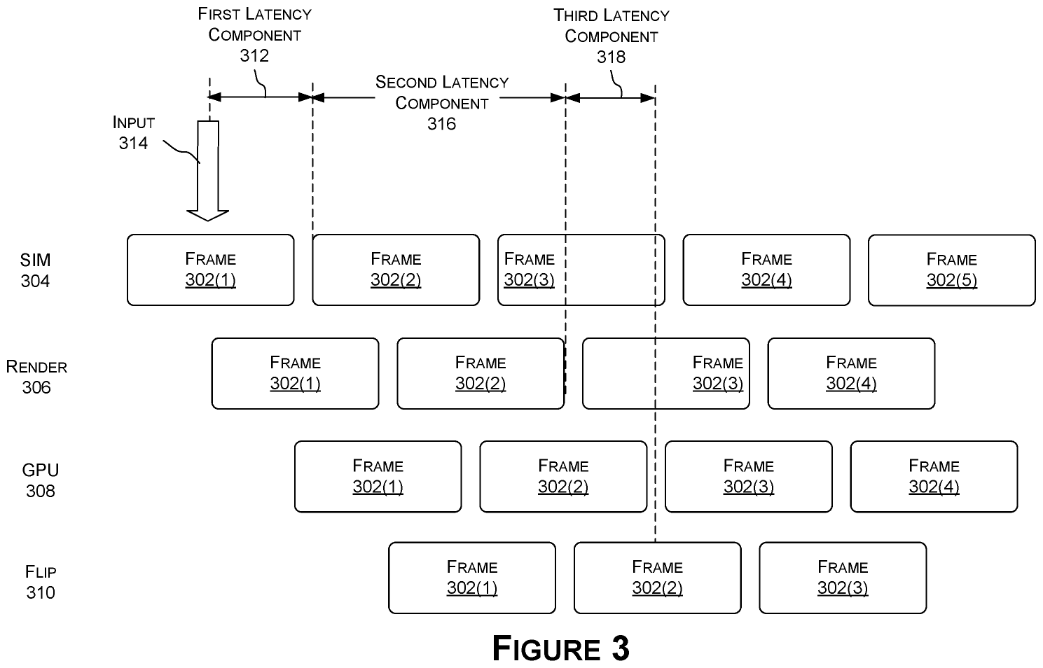

FIG. 3 illustrates an example of determining a device latency associated with a system, in accordance with some embodiments of the present disclosure. As shown, the example of FIG. 3 shows processing that may occur to frames 302(1)-(5) (also referred to singularly as “frame 302” or in plural as “frames 302”) associated with an application, such as a gaming application. For instance, and as shown, the frames 302 may initially be simulated 304, then rendered 306, processed by a GPU 308, and flipped (e.g., a frame buffer flip, a display flip, etc.). However, in other examples, the frames 302 may be processed using one or more additional and/or alternative processes or operations.

As shown by the example of FIG. 3, a system(s) may determine a first latency component 312 as a time period between when an input 314 event occurs (e.g., a virtual input, an actual user input, etc.) and the frame 302(2) that represents the input 314 starts to be simulated. For instance, even though the input 314 occurred while the frame 302(1) was being simulated, the input 314 is not represented until the next frame 302(2). Additionally, the system(s) may determine a second latency component 316 as a time period between when the frame 302(1) starts to be simulated and when rendering of the frame 302(2) ends (e.g., a present call associated with the frame 302(2) occurs). Furthermore, the system(s) may determine a third latency component 318 as a time period between when the rendering of the frame 302(2) ends (e.g., a present call associated with the frame 302(2) occurs) and the flip occurs with the frame 302(2). The system(s) may then determine a device latency by adding the first latency component 312, the second latency component 316, and the third latency component 318.

In some examples, one or more frames associated with an application may be dropped and/or not displayed to a user for various reasons, such as based on the frame rate of the application, the refresh rate of the display, network conditions, and/or the like. For example, if the frame rate of the application includes a first frame rate, such as 200 frames-per-second (FPS), and the display includes a second, lower frame rate, such as 60 FPS, then one or more of the frames may be dropped and, as such, not presented on the display. In such examples, the dropped frames may impact the device latency calculation since the dropped frames may not include the third latency component (e.g., since the frames are not presented). As such, the system(s) may not use the dropped frames when determining the device latency.

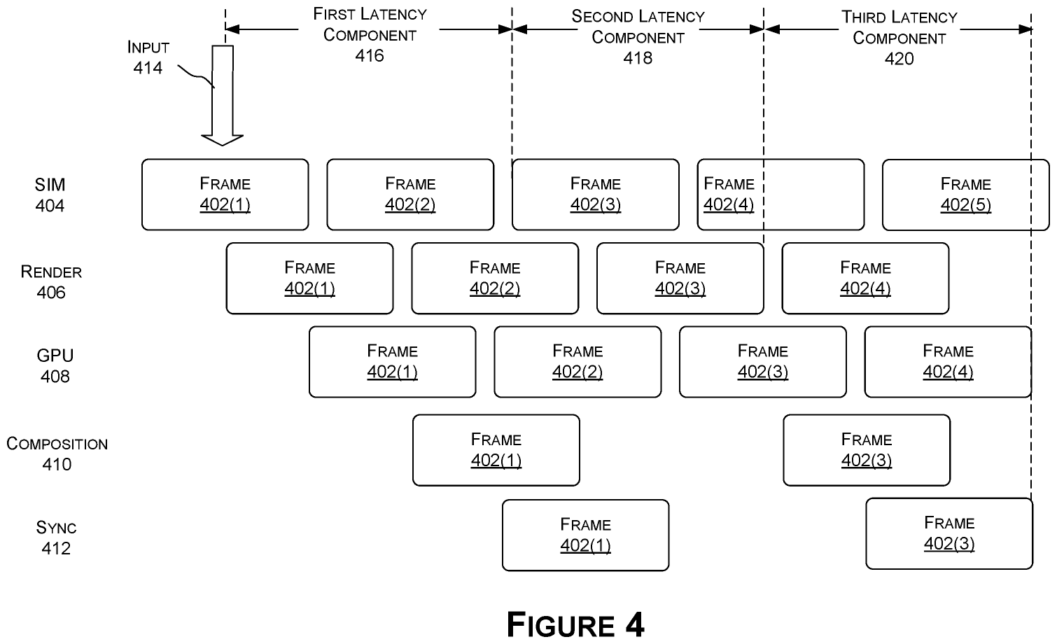

For instance, FIG. 4 illustrates an example of determining a device latency associated with a system when one or more frames are dropped, in accordance with some embodiments of the present disclosure. As shown, the example of FIG. 4 shows processing that may occur to frames 402(1)-(5) (also referred to singularly as “frame 402” or in plural as “frames 402”) associated with an application, such as a gaming application. For instance, and as shown, the frames 402 may initially be simulated 404, then rendered 406, then processed by a GPU 408, then processed using one or more composition 410 techniques, and then synced 412 with a display, such as when the frame rate of the display is less than the frame rate of the application. However, in other examples, the frames 402 may be processed using one or more additional and/or alternative processes.

As shown, not all of the frames 402 that are generated by the application are displayed to a user. For instance, and in the example of FIG. 4, every other frame 402 may not be processed using the one or more composition 410 techniques and/or may not be synced 412 with the display. As such, even though the frame 402(2) includes the next frame after an input 414 occurs, such that the input 414 is detected when sampling the frame 402(2), the frame 402(2) is dropped and not displayed to the user. Rather, the frame 402(3) includes the first frame that is presented to the user after the input 414 is sampled. Because of this, the system(s) may perform one or more additional and/or alternative techniques when determining the device latency.

For instance, since the frame 402(3) is the first simulated frame that is also displayed to the user after the input 414 event is sampled, the system(s) may determine a first latency component 416 as a time period between when the input 414 event occurs (e.g., a virtual input, an actual user input, etc.) and the frame 402(3) starts to be simulated. For instance, even though the frame 402(2) is simulated after the input 414 event, the frame 402(2) is not displayed to the user and, as such, the frame 402(2) is not used when determining the latency. Additionally, the system(s) may determine a second latency component 418 as a time period between when the frame 402(3) starts to be simulated and when rendering of the frame 402(3) ends (e.g., a present call associated with the frame 402(3) occurs). Furthermore, the system(s) may determine a third latency component 420 as a time period between when the rendering of the frame 402(3) ends and when the frame 402(3) is synced 412 for display (e.g., a frame buffer flip associated with the frame 402(3) occurs.). The system(s) may then determine a device latency by adding the first latency component 416, the second latency component 418, and the third latency component 420.

In some examples, the system(s) may perform additional processing associated with frames, such as increasing a frame rate associated with the application by generating additional frames using the frames generated and/or presented by the application. For example, a component of the system(s) may intercept a present call associated with a frame (referred to as a “called frame” in these examples). The component may then generate a new frame using the called frame and a previous frame generated by the application (and, in some examples, using additional characteristics, such as an optical flow field generated by an accelerator, game engine data, such as motion vectors and depth, and/or other information associated with the application). For example, the component may analyze the frame and calculate an optical flow field, where the optical flow field captures the direction and speed at which pixels are moving from the previous frame to the called frame. The component may then be able to capture pixel-level information, such as particles, reflections, shadows, and lighting, which may be included in the application engine vector calculations. The component may then use information from the motion vectors, the optical flow field, and the sequential frames (e.g., the previous frame and the called frame) to create the new, intermediate frame.

The system(s) may then cause each of the frames to be presented. For example, the system(s) may cause the previous frame to be presented, followed by the new frame, and finally followed by the called frame. In some examples, the system(s) presents each of the frames using one or more delays. For example, the system(s) may present the new frame after a first delay from the presentation of the previous frame, and then present the called frame after a second delay from the presentation of the new frame. While this example only describes generating one new frame between two other frames, in other examples, the component may generate any number of new frames.

In some examples, to support such a process, the system(s) may generate new out-of-band (OOB) markers to replace the present markers (e.g., the present marker 214) since additional frames are now being presented by the computing device(s) 110. As such, the system(s) may use these OOB markers to determine the device latency associated with the computing device(s) 110. For example, and using the example above, the system(s) may determine a first latency component associated with the called frame using similar techniques as the system(s) used to determine the first latency component 136 described herein. However, the system(s) may then determine a second latency component as including a time period between when simulation associated with the called frame started and an OOB marker indicates the new frame was presented. Additionally, the system(s) may determine a third latency component as including a time period between when the simulation associated with the called frame started and OOB marker indicates that the called frame was presented.

The system(s) may then determine a first device latency associated with the called frame using the first latency component and the second latency component. For example, the system(s) may determine the first device latency associated with the called frame by adding the first latency component and the second latency component. The system(s) may also determine a second device latency associated with the called frame using the first latency component and the third latency component. For example, the system(s) may determine the second device latency associated with the called frame by adding the first latency component and the third latency component. The system(s) may then determine a final device latency associated with the called frame using the first device latency and the second device latency.

For instance, and in some examples, the system(s) may determine the final device latency as an average of the first device latency and the second device latency. In some examples, the system(s) may determine the final device latency as a lowest latency between the first device latency and the second device latency. Still, in some examples, the system(s) may determine the final device latency as the greater latency between the first device latency and the second device latency. While these are just a couple example techniques of how the system(s) may determine the final device latency using the first device latency and the second device latency, in other examples, the system(s) may determine the final device latency using one or more additional and/or alternative techniques.

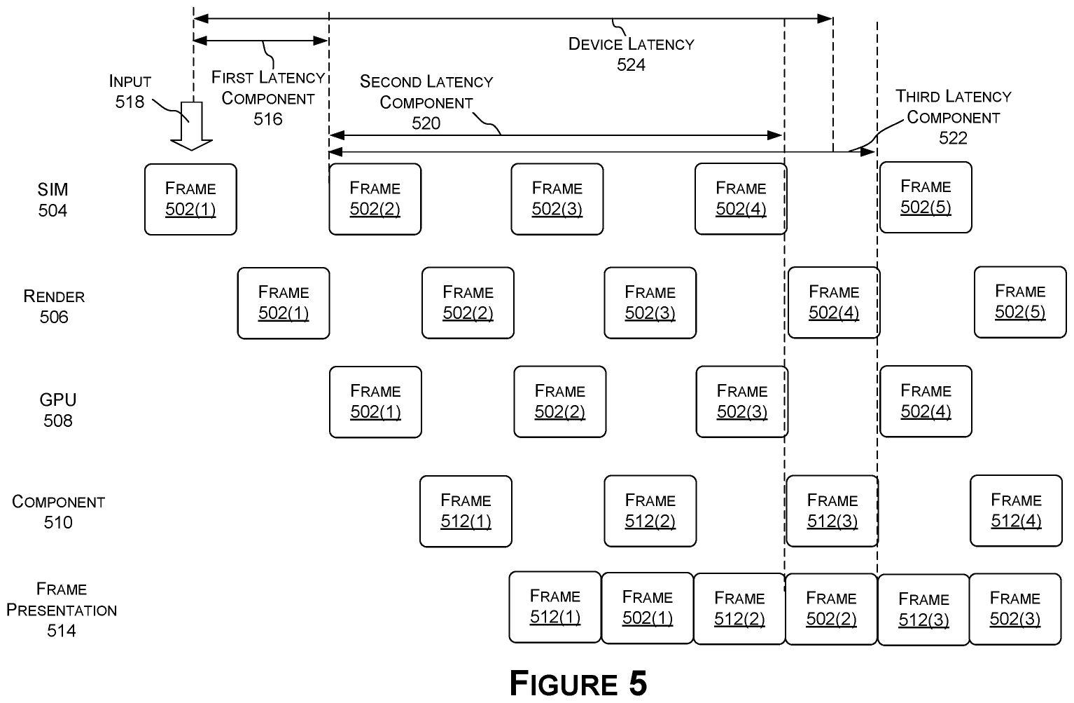

For instance, FIG. 5 illustrates an example of determining a device latency associated with a system when the system uses additional processing to generate additional frames, in accordance with some embodiments of the present disclosure. As shown, the example of FIG. 5 shows processing that may occur to frames 502(1)-(5) (also referred to singularly as “frame 502” or in plural as “frames 502”) associated with an application, such as a gaming application. For instance, and as shown, the frames 502 may initially be simulated 504, then rendered 506, and then processed by a GPU 508. In addition, and as also shown by the example of FIG. 5, a component 510 (e.g., an AI component) may generate a frame 512(1) using the frame 502(1) and another frame (e.g., a frame that is generated prior to the frame 502(1)), generate a frame 512(2) using the frame 502(1) and the frame 502(2), generate a frame 512(3) using the frame 502(2) and the frame 502(3), and generate a frame 502(4) using the frame 502(3) and the frame 502(4). The system(s) may then present 514 the frames 502 and 512.

As such, the system(s) may determine a first latency component 516 as a time period between when an input 518 event occurred and when simulation associated with the frame 502(2) started. As described herein, the system(s) may determine the first latency component 516 using similar processes as the first latency component 136. The system(s) may then determine a second latency component 520 as including a time period between when the simulation associated with the frame 502(2) started and the frame 512(1) was presented (e.g., a time associated with a OOB marker of the frame 512(1)). Additionally, the system(s) may determine a third latency component 522 as including a time period between when the simulation associated with the frame 502(2) started and the frame 502(2) was presented (e.g., a time associated with a OOB marker of the frame 502(2)).

The system(s) may then determine a first device latency associated with the frame 502(2) using the first latency component 516 and the second latency component 520. For example, the system(s) may determine the first device latency associated with the frame 502(2) by adding the first latency component 516 and the second latency component 520. The system(s) may also determine a second device latency associated with the frame 502(2) using the first latency component 516 and the third latency component 522. For example, the system(s) may determine the second device latency associated with the frame 502(2) by adding the first latency component 516 and the third latency component 522. The system(s) may then determine a final device latency 524 associated with the frame 50(2) using the first device latency and the second device latency.

For instance, and in some examples, the system(s) may determine the final device latency 524 as an average of the first device latency and the second device latency. In some examples, the system(s) may determine the final device latency 524 as a lowest latency between the first device latency and the second device latency. Still, in some examples, the system(s) may determine the final device latency 524 as a greatest latency between the first device latency and the second device latency. While these are just a couple example techniques of how the system(s) may determine the final device latency 524 using the first device latency and the second device latency, in other examples, the system(s) may determine the final device latency 524 using one or more additional and/or alternative techniques.

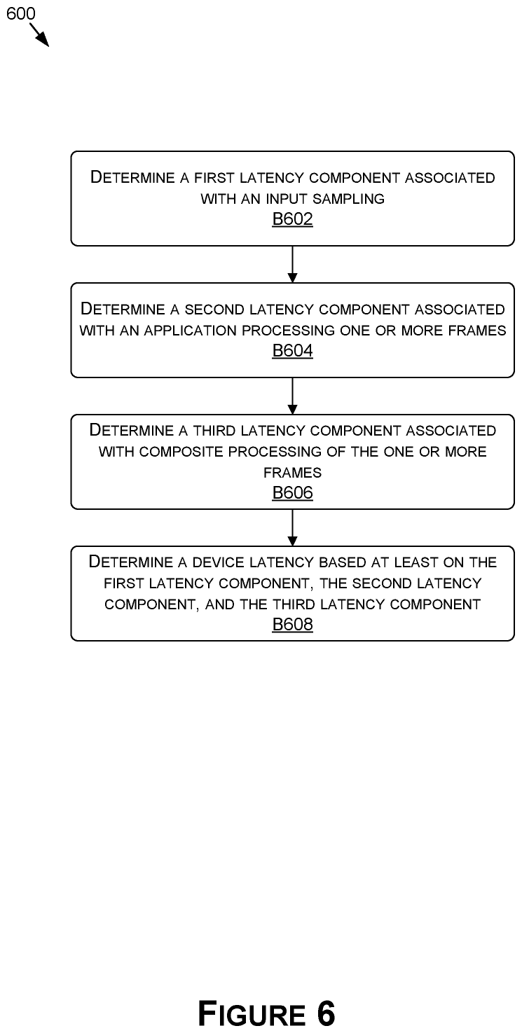

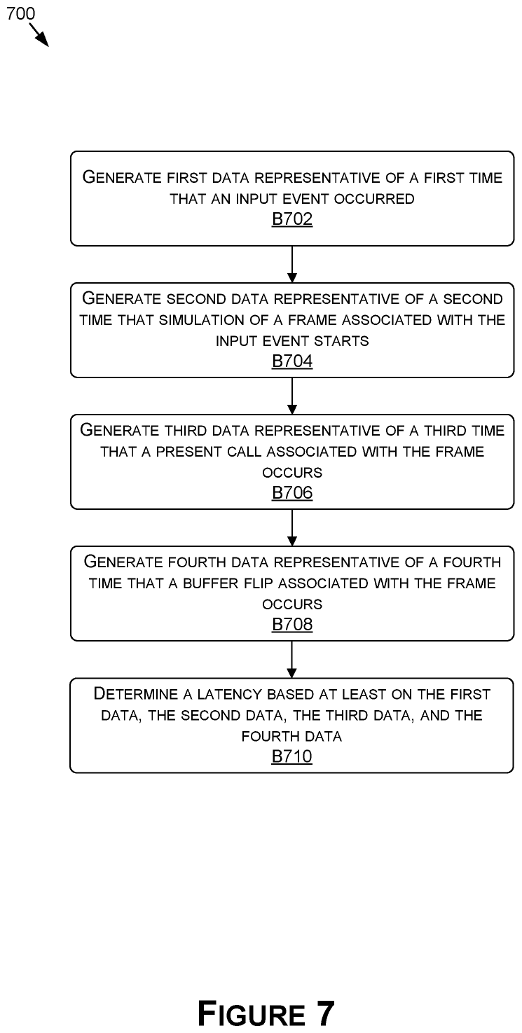

Now referring to FIGS. 6-7, each block of methods 600 and 700, described herein, comprises a computing process that may be performed using any combination of hardware, firmware, and/or software. For instance, various functions may be carried out by a processor executing instructions stored in memory. The methods 600 and 700 may also be embodied as computer-usable instructions stored on computer storage media. The methods 600 and 700 may be provided by a standalone application, a service or hosted service (standalone or in combination with another hosted service), or a plug-in to another product, to name a few. In addition, the methods 600 and 700 are described, by way of example, with respect to FIG. 1. However, the methods 600 and 700 may additionally or alternatively be executed by any one system, or any combination of systems, including, but not limited to, those described herein.

FIG. 6 is a flow diagram showing a method 600 for determining a latency associated with a computing device, in accordance with some embodiments of the present disclosure. The method 600, at block B602, may include determining a first latency component associated with input sampling. For instance, the system(s) may determine the first latency component 136 associated with the computing device(s) 110, where the first latency component 136 is based at least on input sampling. As described herein, the system(s) may determine the first latency component 136 using markers, such as a first marker indicating when an input event occurs and a second marker indicating when a frame associated with the input event begins simulation. For instance, the system(s) may determine the first latency component 136 as a time difference between a first time associated with the first marker and a second time associated with the second marker.

The method 600, at block B604, may include determining a second latency component associated with an application processing one or more frames. For instance, the system(s) may determine the second latency component 138 associated with the computing device(s) 110, where the second latency component 138 is associated with at least the application generating one or more frames. As described herein, the system(s) may determine the second latency component 138 using markers, such as the second marker indicating when the frame associated with the input event began simulation and a third marker indicating when a present call associated with the frame occurred. For instance, the system(s) may determine the second latency component 138 as a time difference between the second time associated with the second marker and a third time associated with the third marker.

The method 600, at block B606, may include determining a third latency component associated with composite processing of the one or more frames. For instance, the system(s) may determine the third latency component 140 associated with the computing device(s) 110, where the third latency component 140 is associated with at least the composite processing of the one or more frames. As described herein, the system(s) may determine the third latency component 140 using markers, such as the third marker indicating when the present call associated with the frame occurred and a fourth marker indicating when a frame buffer flip associated with the frame occurred. For instance, the system(s) may determine the third latency component 140 as a time difference between the third time associated with the third marker and a fourth time associated with the fourth marker.

The method 600, at block B608, may include determining a device latency based at least on the first latency component, the second latency component, and the third latency component. For instance, the system(s) may determine the device latency 108 based on the first latency component 136, the second latency component 138, and the third latency component 140. In some examples, the system(s) determines the device latency 108 by adding the first latency component 136, the second latency component 138, and the third latency component 140. In some examples, the system(s) may also determine a peripheral latency 104 and a display latency 112. The system(s) may then determine the system latency 102 based on the peripheral latency 104, the device latency 108, and the display latency 112. For instance, the system(s) may determine the system latency 102 by adding the peripheral latency 104, the device latency 108, and the display latency 112.

FIG. 7 is a flow diagram showing a method 700 for using markers to determine a latency associated with a computing device, in accordance with some embodiments of the present disclosure. The method 700, at block B702, may include generating first data representative of a first time that an input event occurs. For instance, the system(s) may generate the first data associated with the input event, where the first data represents at least the first time. In some examples, the first data may correspond to a marker that indicates at least the first time. As described herein, the input event may include an actual input, such as an input from a peripheral device 106 in possession of a user, or the input event may include a virtual input, such as a ping generated by the application.

The method 700, at block B704, may include generating second data representative of a second time that simulation of a frame associated with the input event starts. For instance, the system(s) may generate the second data associated with the simulation, where the second data represents at least the second time and an identifier associated with the frame. In some examples, the second data may correspond to a marker that indicates at least the second time and the identifier associated with the frame.

The method 700, at block B706, may include generating third data representative of a third time that a present call associated with the frame occurs. For instance, the system(s) may generate the third data associated with the present call, where the third data represents at least the third time and the identifier associated with the frame. In some examples, the third data may correspond to a marker that indicates at least the third time and the identifier associated with the frame.

The method 700, at block B708, may include generating fourth data representative of a fourth time that a buffer flip associated with the frame occurs. For instance, the system(s) may generate the fourth data associated with the buffer flip, where the fourth data represents at least the fourth time. In some examples, the fourth data may correspond to a marker that indicates at least the fourth time. In some examples, the fourth data may further be representative of the identifier associated with the frame and/or the system(s) may associate the fourth data with the identifier associated with the frame.

The method 700, at block B710, may include determining a latency based at least on at least one of the first data, the second data, the third data, or the fourth data. For instance, the system(s) may use the first data, the second data, the third data, and/or the fourth data to determine the device latency 108. In some examples, to make the determination, the system(s) may determine the first latency component 136 using the first data and the second data, the second latency component 138 using the second data and the third data, and the third latency component 140 using the third data and the fourth data. The system(s) may then determine the device latency 108 using the first latency component 136, the second latency component 138, and the third latency component 140.

Example Content Streaming System

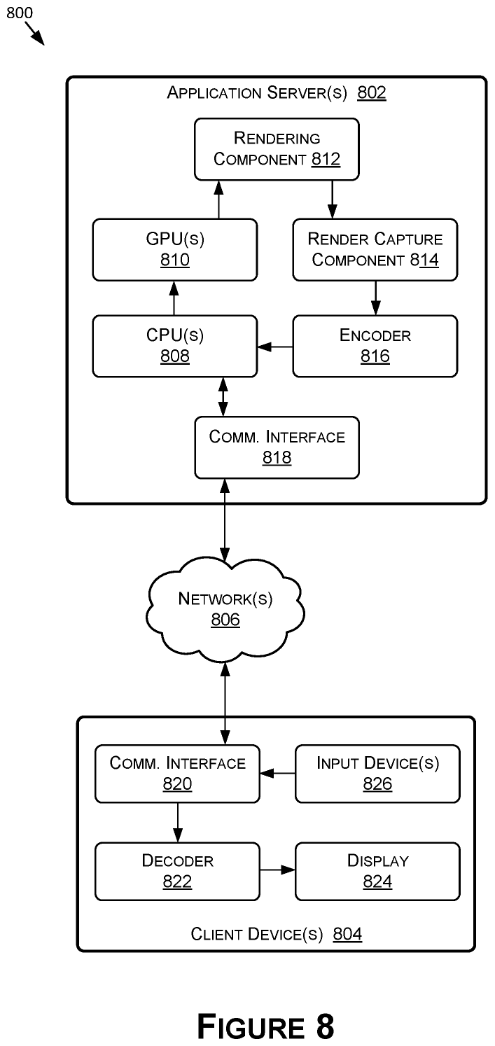

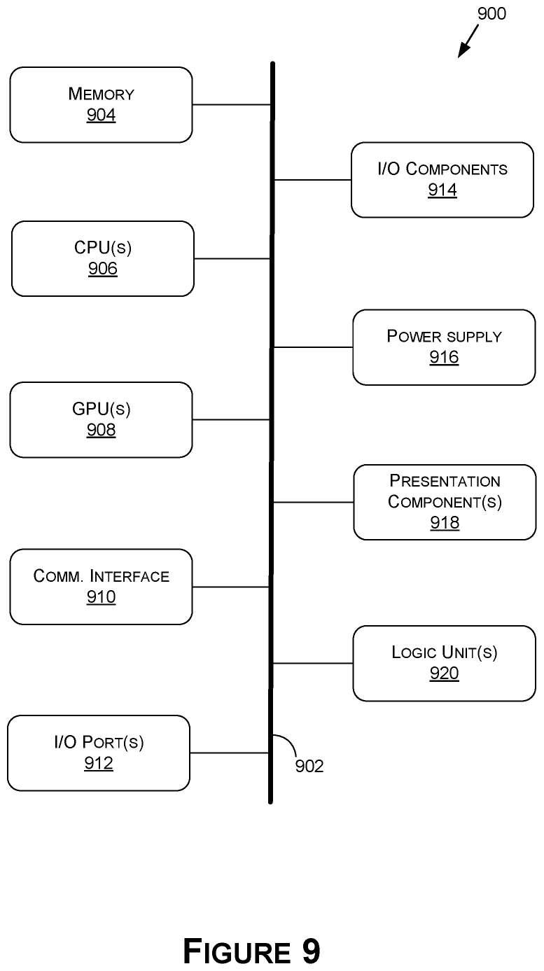

Now referring to FIG. 8, FIG. 8 is an example system diagram for a content streaming system 800, in accordance with some embodiments of the present disclosure. FIG. 8 includes application server(s) 802 (which may include similar components, features, and/or functionality to the example computing device 900 of FIG. 9), client device(s) 804 (which may include similar components, features, and/or functionality to the example computing device 900 of FIG. 9), and network(s) 806 (which may be similar to the network(s) described herein). In some embodiments of the present disclosure, the system 800 may be implemented. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 800, for an application session, the client device(s) 804 may only receive input data in response to inputs to the input device(s), transmit the input data to the application server(s) 802, receive encoded display data from the application server(s) 802, and display the display data on the display 824. As such, the more computationally intense computing and processing is offloaded to the application server(s) 802 (e.g., rendering—in particular ray or path tracing—for graphical output of the application session is executed by the GPU(s) of the game server(s) 802). In other words, the application session is streamed to the client device(s) 804 from the application server(s) 802, thereby reducing the requirements of the client device(s) 804 for graphics processing and rendering.

For example, with respect to an instantiation of an application session, a client device 804 may be displaying a frame of the application session on the display 824 based on receiving the display data from the application server(s) 802. The client device 804 may receive an input to one of the input device(s) and generate input data in response. The client device 804 may transmit the input data to the application server(s) 802 via the communication interface 820 and over the network(s) 806 (e.g., the Internet), and the application server(s) 802 may receive the input data via the communication interface 818. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 812 may render the application session (e.g., representative of the result of the input data) and the render capture component 814 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 802. In some embodiments, one or more virtual machines (VMs)— e.g., including one or more virtual components, such as vGPUs, vCPUs, etc.—may be used by the application server(s) 802 to support the application sessions. The encoder 816 may then encode the display data to generate encoded display data and the encoded display data may be transmitted to the client device 804 over the network(s) 806 via the communication interface 818. The client device 804 may receive the encoded display data via the communication interface 820 and the decoder 822 may decode the encoded display data to generate the display data. The client device 804 may then display the display data via the display 824.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, game streaming, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for streaming games, systems implemented at least partially using cloud computing resources, and/or other types of systems.

Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

Example Data Center

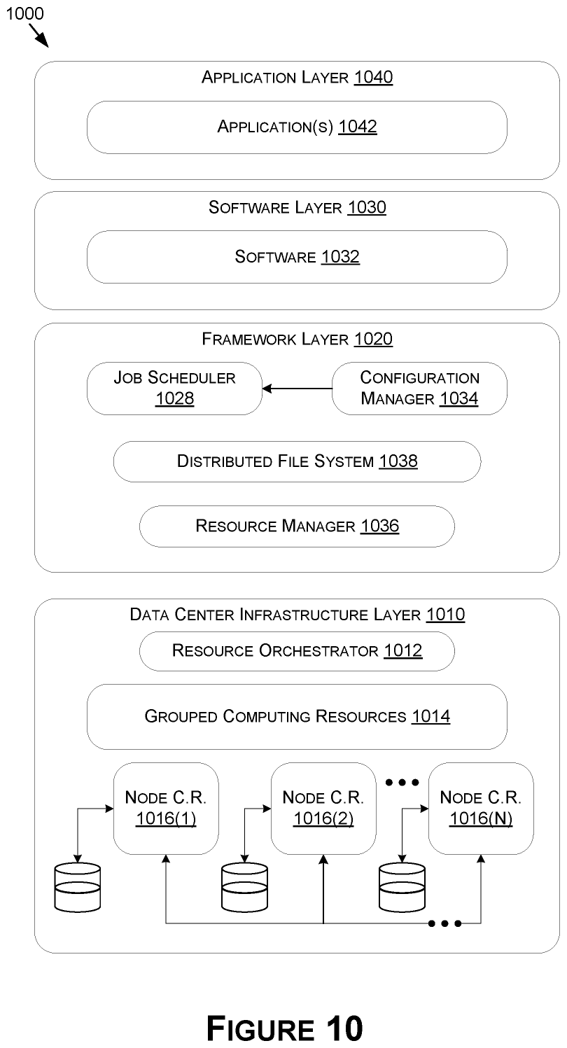

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
determining a first time that an input event associated with a software application is sent;
determining a second time associated with simulating a frame corresponding to the input event;
computing a first latency based at least on the first time and the second time;
determining a third time that at least one of a present call associated with the frame occurs or a frame buffer flip associated with the frame occurs; and
computing a second latency based at least on the first latency and the third time.

2. The method of claim 1, wherein the computing the second latency comprises:
computing a third latency based at least on the second time and the third time; and
computing the second latency by adding the first latency to the third latency.

3. The method of claim 1, wherein the third time corresponds to a time the frame buffer flip associated with the frame occurs, and wherein the method further comprises:
determining a fourth time that the present call associated with the frame occurs;
computing a third latency based at least on the second time and the fourth time; and
computing a fourth latency based at least on the fourth time and the third time,
wherein the computing the second latency comprises computing the second latency based at least on the first latency, the third latency, and the fourth latency.

4. The method of claim 1, further comprising:
determining a fourth time that a second input event associated with the software application is sent; and
determining a fifth time associated with simulating a second frame corresponding to the second input event,
wherein the computing the first latency is further based at least on the fourth time and the fifth time.

5. The method of claim 4, further comprising:
computing a third latency based at least on the first time and the second time; and
computing a fourth latency based at least on the fourth time and the fifth time,
wherein the computing the first latency comprises computing the first latency based at least on an average of the third latency and the fourth latency.

6. The method of claim 4, further comprising causing, based at least on a predetermined time period elapsing since the first time, the second input event to occur.

7. The method of claim 1, further comprising:
based at least on the input event occurring, generating first data representative of at least the first time;
based at least on the frame corresponding to the input event being simulated, generating second data representative of at least the second time and an identifier associated with the frame; and
based at least on a detection of the input event, generating third data that associates at least the input event with the identifier associated with the frame,
wherein the computing the first latency is based at least on the first data, the second data, and the third data.

8. The method of claim 1, further comprising:
determining a fourth time that at least one of a second present call associated with a second frame occurs or a second frame buffer flip associated with the second frame occurs, wherein the second frame is generated based at least on the frame;
computing a third latency based at least on the first latency and the fourth time; and
computing a fourth latency based at least on the second latency and the third latency.

9. The method of claim 1, further comprising:
computing a third latency associated with a peripheral device that receives one or more inputs associated with the software application;
computing a fourth latency associated with a display device that presents at least the frame; and
computing a fifth latency based at least on the second latency, the third latency, and the fourth latency.

10. A system comprising:
one or more processing units to:
determine a first time that a frame associated with a software application is simulated;
determine a second time that a frame buffer flip associated with the frame occurs; and
compute, based at least on the first time and the second time, a latency associated with the software application.

11. The system of claim 10, wherein the one or more processing units are further to:
determine a third time that a present call associated with the frame occurs;
compute, based least on the first time and the third time, a second latency; and
compute, based at least on the third time and the second time, a third latency,
wherein the latency associated with the software application is computed based at least on the second latency and the third latency.

12. The system of claim 10, wherein the one or more processing units are further to:
based at least on a present call associated with the frame occurring, generate data representing at least an identifier associated with the frame; and
determine, based at least on the data, that the frame buffer flip is associated with the frame,
wherein the latency is further computed based at least on the determination that the frame buffer flip is associated with the frame.

13. The system of claim 10, wherein the one or more processing units are further to:
determine a third time that an input event associated with the software application is sent, wherein the frame is associated with the input event,
wherein the latency is further computed based at least on the third time.

14. The system of claim 13, wherein the one or more processing units are further to:
compute, based at least on the third time and the first time, a second latency; and
compute, based at least on the first time and the second time, a third latency,
wherein the latency associated with the software application is computed based at least on the second latency and the third latency.

15. The system of claim 14, wherein the one or more processing units are further to:
determine a fourth time that a second input event associated with the software application is sent;
determine a fifth time that a second frame associated with the second input event is simulated;
determine, based at least on the fourth time and the fifth time, a fourth latency; and
compute a fifth latency based at least on an average of the second latency and the fourth latency,
wherein the latency associated with the software application is computed based at least on the fifth latency and the third latency.

16. The system of claim 10, wherein the one or more processing units are further to:
based at least on the frame associated with the software application being simulated, generate first data representative of at least the first time and an identifier associated with the frame; and
based at least on the frame buffer flip associated with the frame occurring, generate second data representative of at least the second time,
wherein the latency associated with the software application is computed based at least on the first data and the second data.

17. The system of claim 10, wherein the one or more processing units are further to:
compute a second latency associated with a peripheral device that receives one or more inputs associated with the software application;
compute a third latency associated with a display device that presents at least the frame; and
compute a fourth latency based at least on the first latency, the second latency, and the third latency.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

19. A processor comprising:
one or more processing units to compute a latency associated with a computing device based at least on a first time that an input event associated with a software application occurs and a second time that a frame buffer flip associated with a frame of the software application occurs, wherein the frame is associated with sampling the input event.

20. The processor of claim 18, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
